(19) United States
(12) Patent Application Publication
(10) Pub. No.: US 2013/0340617 A1
(43) Pub. Date: Dec. 26, 2013

(54) RADIATOR GRILL

(71) Applicant: HONDA MOTOR CO., LTD., Tokyo (JP)

(72) Inventors: Jack Havelin, Valencia, CA (US); Jason Castillo, Castaic, CA (US)

(21) Appl. No.: 13/915,781

(22) Filed: Jun. 12, 2013

Related U.S. Application Data
(60) Provisional application No. 61/661,910, filed on Jun. 20, 2012.

(51) Int. Cl. B60R 19/52

(52) U.S. Cl. CPC B60R 19/52
USPC 95/272; 165/148; 296/193.1

(57) ABSTRACT

A grill for a radiator of a vehicle includes a plurality of spaced blades. Each blade has an upstream section and a downstream section. A first blade of the plurality of blades includes a first curved portion located on the downstream section of the first blade. A second blade of the plurality of blades located adjacent to and above the first blade includes a second curved portion located on the downstream section of the second blade. Each of the first and second curved portions of the respective first and second blades is configured to impart a swirl to airflow entering the curved portion which causes debris entrained in airflow to be separated from the airflow.

The present application claims priority to U.S. Prov. Patent App. Ser. No. 61/661,910 filed on Jun. 20, 2012, the disclosure of which is incorporated herein in its entirety by reference.

### BACKGROUND

One problem with vehicle cooling systems is that debris can adhere to the fins of a radiator which, in turn, can reduce the efficiency of the cooling system. This reduced efficiency can lead to increased operating temperatures and potential engine failure. Past solutions to this debris problem have utilized screens or ducting with forced air. However, screens tend to fill with debris and can decrease airflow, and ducting with forced air can add weight to the vehicle due to the typical use of fans or other like manners to draw air into and through the radiator.

### BRIEF DESCRIPTION

In accordance with one aspect, a grill for a radiator of a vehicle comprises a plurality of spaced blades. Each blade has an upstream section and a downstream section. A first blade of the plurality of blades includes a first curved portion located on the downstream section of the first blade. A second blade of the plurality of blades located adjacent to and above the first blade includes a second curved portion located on the downstream section of the second blade. Each of the first and second curved portions of the respective first and second blades is configured to impart a swirl to airflow entering the curved portion which causes debris entrained in airflow to be separated from the airflow.

In accordance with another aspect, a cooling system for a vehicle comprises a radiator and a grill disposed upstream of the radiator to at least partially cover an upstream face of the radiator. The grill includes a plurality of spaced blades, with each blade having an upstream section and a downstream section. At least one blade of the plurality of blades includes a curved portion located on the downstream section configured to cause debris entrained in air flowing through the grill to change direction at a slower rate than the airflow allowing the debris to be separated from the airflow.

In accordance with yet another aspect, a method of separating debris entrained in airflow directed toward a radiator of a vehicle cooling system comprises providing a grill having a plurality of blades upstream of the radiator, each of the blades having an upstream section and a downstream section; curving an end portion of the downstream section of at least one blade downwardly relative to an upstream face of the radiator; directing the debris entrained airflow into the curved end portion of the at least one blade; and imparting a swirl to the airflow entering the curved end portion of the at least one blade to cause debris entrained in the airflow to change direction at a slower rate than the airflow allowing the debris to be separated from the airflow.

### BRIEF DESCRIPTION OF THE DRAWINGS

FIG. 1 is a partial schematic view of a known cooling system for a vehicle, the cooling system including a radiator assembly including a radiator and a protective grill located upstream of and secured to the radiator.

FIG. 2 illustrates airflow entrained with debris flowing through the known grill of FIG. 1.

FIG. 3 illustrates airflow entrained with debris flowing through a known duct connected to a radiator.

FIG. 4 is the partial schematic view of the cooling system depicted in FIG. 1 with the grill including a plurality of blades according to the present disclosure.

FIG. 5 is a perspective view of a blade of the grill of FIG. 4 according to one aspect of the present disclosure.

FIGS. 6 and 7 illustrate airflow entrained with debris flowing through the grill of FIG. 4 having the blades of FIG. 5.

FIG. 8 is a perspective view of a blade of the grill of FIG. 4 according to another aspect of the present disclosure.

FIG. 9 illustrates airflow entrained with debris flowing through the grill of FIG. 4 having the blades of FIG. 8.

FIG. 10 is a perspective view of a blade of the grill of FIG. 4 according to yet another aspect of the present disclosure.

FIG. 11 illustrates airflow entrained with debris flowing through the grill of FIG. 4 having the blades of FIG. 10.

### DETAILED DESCRIPTION

It should, of course, be understood that the description and drawings herein are merely illustrative and that various modifications and changes can be made in the structures disclosed without departing from the present disclosure. In general, the figures of the exemplary blades of the radiator grill are not to scale. It will also be appreciated that the various identified components of the exemplary blades of the radiator grill disclosed herein are merely terms of art that may vary from one manufacturer to another and should not be deemed to limit the present disclosure.

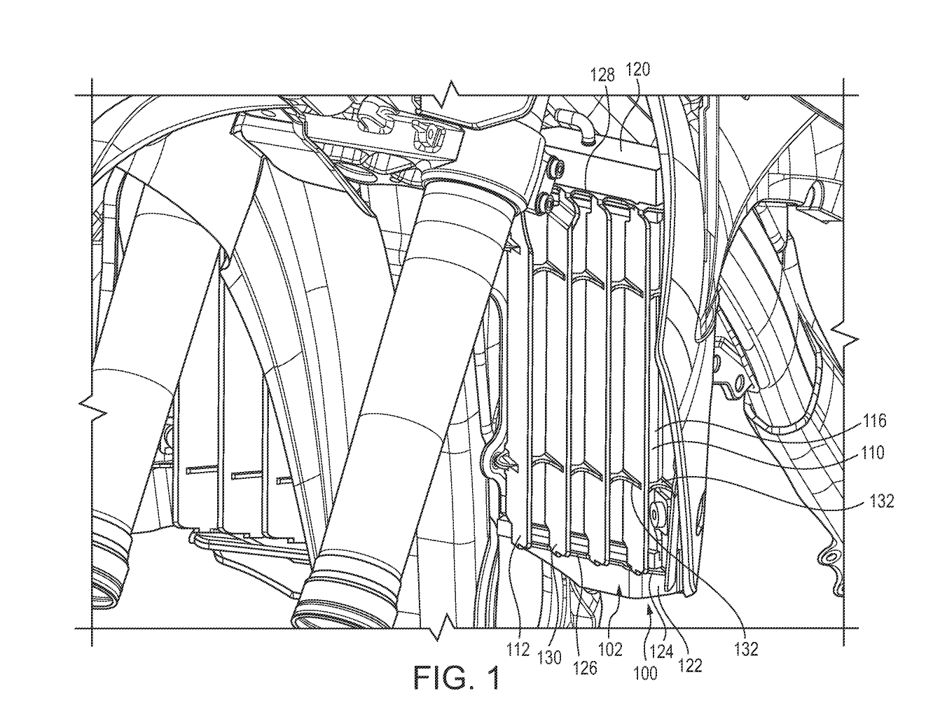

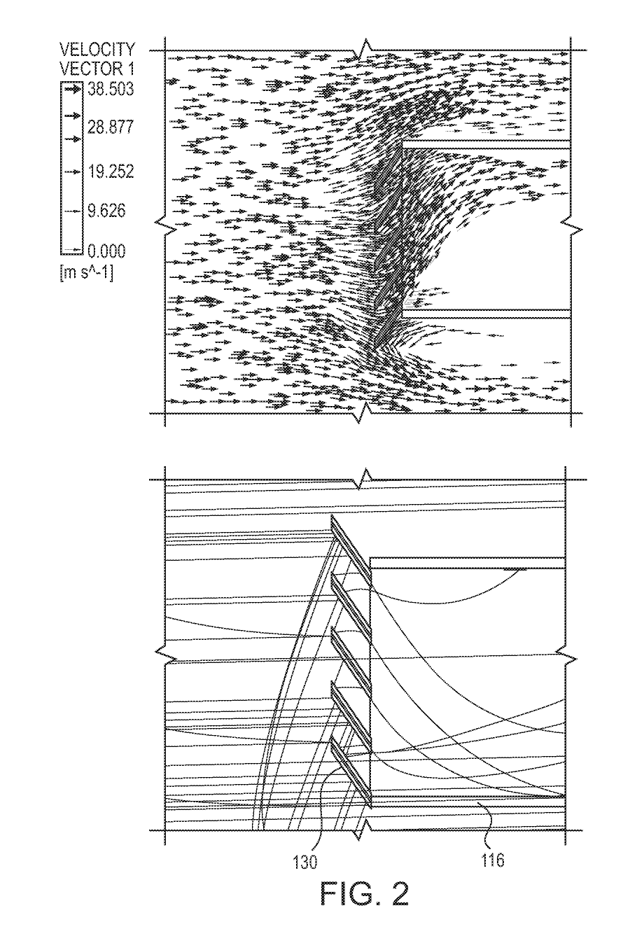

Referring now to the drawings, wherein like numerals refer to like parts throughout the several views, FIG. 1 partially illustrates a known cooling system 100 for a vehicle, such as a motorcycle. The cooling system 100 includes a radiator assembly 102 having a radiator 110 and a cooling fan (not shown) that is typically disposed directly behind or downstream of the radiator 110. The radiator 110 includes an upstream face which typically has a plurality of fins (not shown) canted downwardly relative to the upstream face. A louver or grill 112 is disposed in front or upstream of the upstream face of the radiator 110 to cover the radiator, and can be mounted to the radiator 110. The radiator 110 includes a radiator core 116 having a plurality of fins (not shown), and upper and lower tanks 120 and 122 are disposed along the top side and underside of the radiator core 116, respectively, and can be integrally joined with the radiator core 116. The grill 112 is defined by a grill frame 124 having a pair of sidewalls 126,128 and a plurality of spaced blades 130 that extend between the pair of sidewalls. The blades 130 are interconnected via a plurality of spaced support members 132 which are positioned between adjacent blades 130. Each blade 130 is substantially planar and is oriented angularly downwardly relative to an upstream face of the radiator core 116. With this conventional design of the blades 130, and as shown in FIG. 2, an air flow through the grill 112 is directed generally perpendicular to an upstream face of the radiator core 116 via the blades 130 with about 50% of incident debris entering the radiator 110.

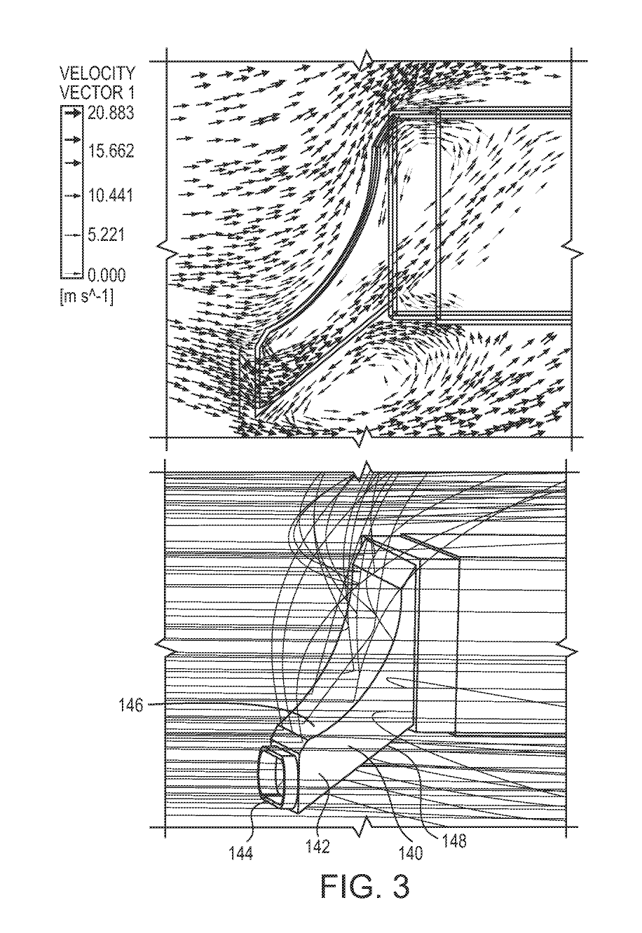

As indicated previously, and as shown in FIG. 3, it is also known to provide a duct 140 upstream from and adjacent the radiator 110 to direct air toward the radiator. The duct 140 includes a body 142 having a forward facing air inlet 144 which is located toward a lower portion of the radiator 110. The body 142 further includes a concaved top wall 146 and a bottom wall 148. Similar to the blades 130, the bottom wall 148 is oriented angularly downwardly relative to the radiator 110. However, with this known arrangement, an air flow entering the duct 140 can be restricted by the size of the air inlet 144, and substantially all of the incident debris enters the radiator. Further, with the duct 140, the mass flow through the duct is about 22.5% of the mass flow through the blades 130.

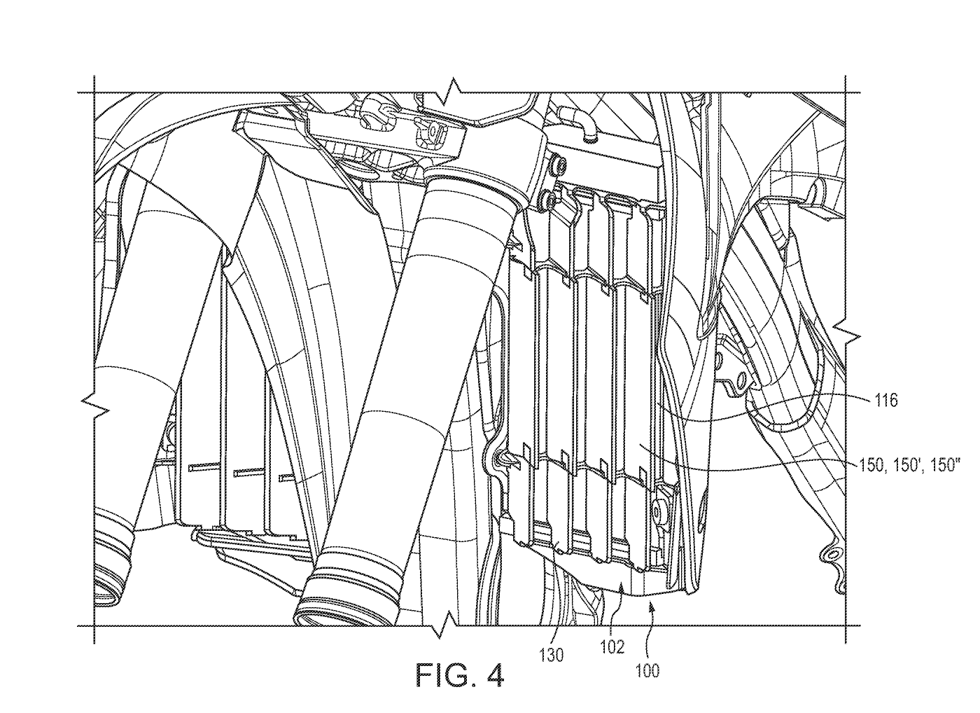

FIG. 4 illustrates the known cooling system 100 of FIG. 1 including a louver or grill 112 located upstream of the radiator and having with a plurality of blades 150,150′,150″ according to the present disclosure. The blades 150,150′,150″ are configured to use the inertia of the debris entrained in the airflow to separate the debris from the airflow and then use centrifugal force to slow the debris and allow it to drop out of the cooling system. According to one embodiment, the blades 150,150′,150″ can be separate add-on components that can be releasably secured to the blades 130 of the grill 112, for example. In this embodiment, the blades 150,150′,150″ can be sized so that the blades extend between the support members 132 (FIG. 1); although, it should be appreciated the blades 150,150′,150″ can be sized to extend between and interconnect the pair of sidewalls 126,128 (FIG. 1). According to another embodiment, the blades 150,150′,150″ can be integrally formed with the grill 112 to define a one-piece unit. As will be discussed in greater detail below, the blades 150,150′,150″ each include a curved portion which causes the debris (e.g., dirt particles) to change direction at a slower rate than the air allowing the two media to be separated. When separated, the curved portion of each blade 150,150′,150″ turns the debris at a high rate, creating friction between the blade 150,150′,150″ and debris, slowing it down and allowing gravity to pull the debris down and out of the cooling system 100. In addition, the curved profile of the each blade 150,150′,150″ decreases the pressure drop across the blade by moving the separation point of the airflow downstream, reducing the area of low pressure behind the blade.

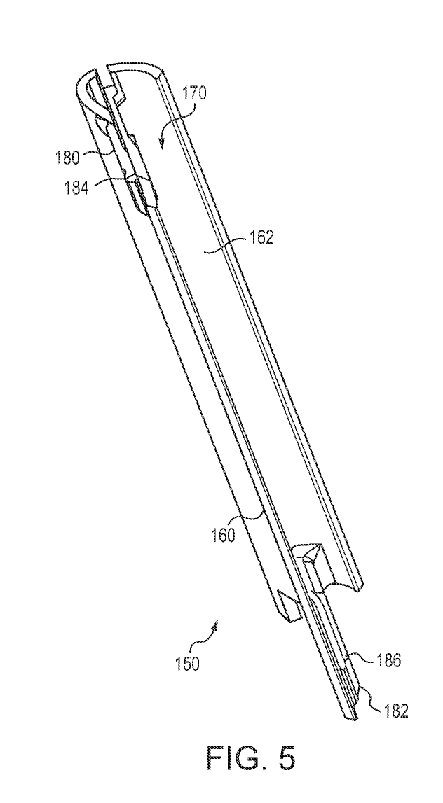

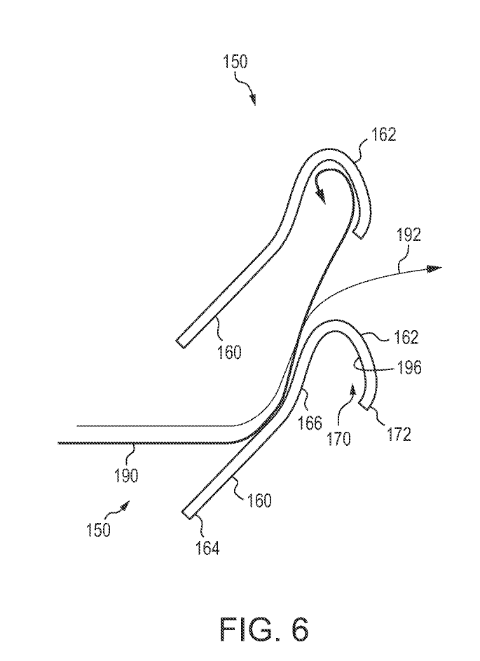

FIGS. 5 and 6 depict the blade 150 according to one aspect of the present disclosure. The blade 150 includes an upstream section 160 and a downstream section 162. The upstream section 160 has a front end 164 from which the upstream section 160 extends upwardly and rearwardly (toward the radiator 110) a predetermined distance and a rear end 166 from which the downstream section 162 rearwardly extends. The downstream section 162 has a generally inverted U-shape in cross-section and defines an elongated channel 170. An end 172 of the downstream section 162 can be curved inwardly toward the channel 170. As indicated previously, the blade 150 can be a separate add-on component that is releasably secured to a blade of a known grill, such as the blade 130 of the grill 112 in FIG. 1. To that end, longitudinal end portions 180,182 of the blade 150, particularly the upstream section 160 of the blade 150, include mounting sections 184,186 configured to be connected to the blade 130. For example, the mounting sections 184,186 can include mounting apertures (not shown) sized to receive fasteners, such as screws, which secure the blade 150 to an outer surface of the blade 130.

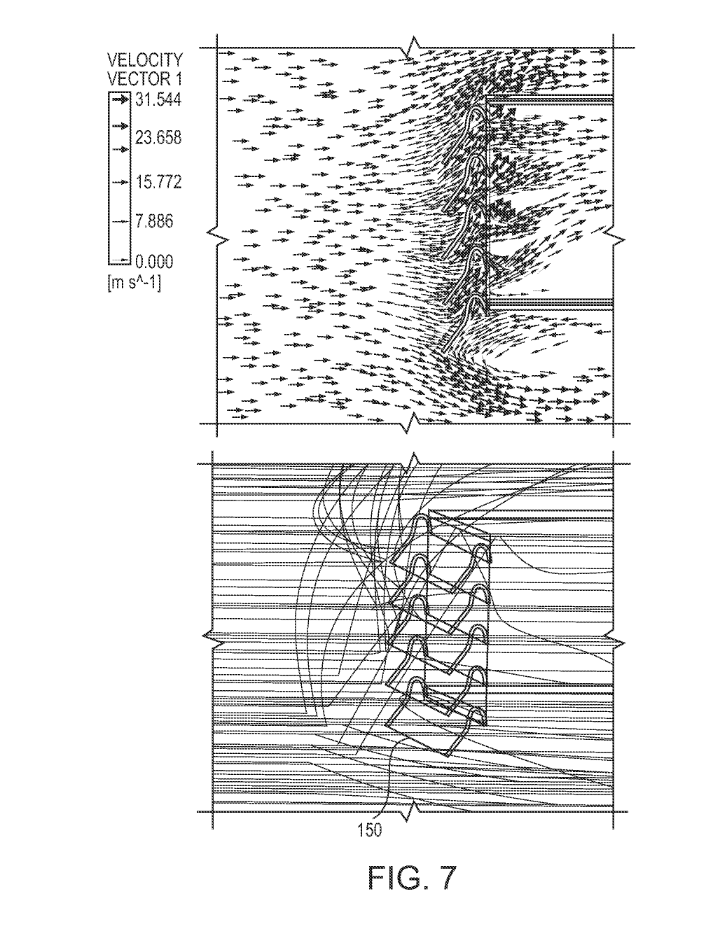

As depicted in FIGS. 6 and 7, airflow through the grill 112 is directed upwardly via the upstream section 160 of one of the blades 150 and toward the downstream section 162 of the blade located a predetermined distance above the one blade. The airflow is then separated into a first airflow 190 which flows into the channel 170 and a second airflow 192 which flows between the blades 150 and toward the radiator 110. The first airflow 190 flowing into the channel 170 is dirt entrained. The channel 170 is shaped so that a swirl is imparted to the first airflow 190 entering the channel. The swirl imparted to the first airflow 190 can create a cyclonic effect in which centrifugal force causes the dirt entrained in the air to be forced to an interior surface 196 of the channel 170 and out of the first airflow 190 allowing gravity to pull the debris down and out of the cooling system. The at least partially cleaned first airflow 190 together with the second airflow 192 is then directed substantially parallel to an upstream face of the radiator via the blades 150 with much less (about 13%) of incident debris entering the radiator 110. The curved profile of the downstream section 162 of the blade 150 decreases the pressure drop across the blade by moving the separation point of the airflow downstream, reducing the area of low pressure behind the blade 150. It should be appreciated that an outer surface of the downstream portion 162 of the uppermost blade 150 directs the airflow over an upper portion of the radiator 110 and the end 172 of the downstream section 162 of the lowermost blade is aligned with a lower portion of the radiator 110 such that the upstream section 160 of the lowermost blade 150 directs the airflow away from the lower portion of the radiator 110. Further, with this design of the blade 150, the mass flow through the blades 150 is approximately equal to the mass flow through the blades 130.

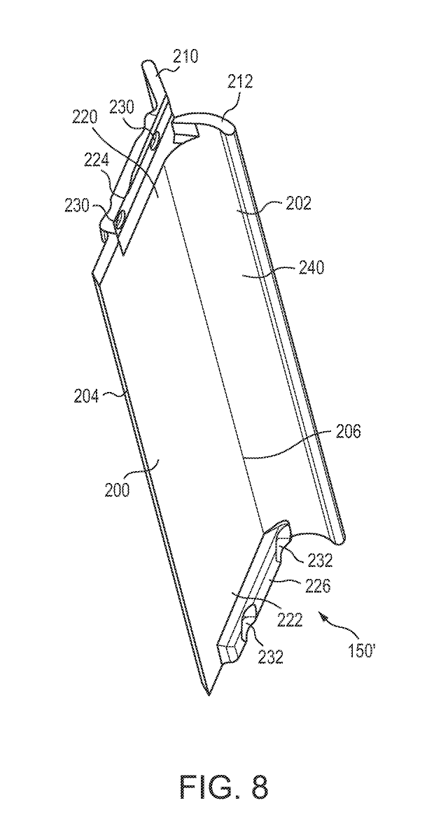

FIG. 8 depicts a blade 150′ according to another aspect of the present disclosure. The blade 150′ includes an upstream section 200 and a downstream section 202. The upstream section 200 has a front end 204 from which the upstream section 200 extends upwardly and rearwardly (toward the radiator 110) a predetermined distance and a rear end 206 from which the downstream section 202 rearwardly extends. The downstream section 202 includes a first part 210 and a second part 212, each part 210,212 projecting from the rear end 206 of the upstream section 200. The first part 210 extends substantially parallel to an upstream face of the radiator 110 and toward the rear end 206 of the blade located immediately above the first part 210. The second part 212 is curved downwardly and toward the upstream face of the radiator and together with the upstream section 200 have a generally reverse L-shape in cross-section. As indicated previously, the blade 150′ can be a separate add-on component that is releasably secured to a blade of a known grill, such as the blade 130 of the grill 112. To that end, longitudinal end portions 220,222 of the blade 150′, particularly the upstream section 200 of the blade, include mounting sections 224,226 configured to be connected to the blade 130. The mounting sections 224,226 can include mounting apertures 230,232 sized to receive fasteners, such as screws, which secure the blade 150′ to an outer surface of the blade 130.

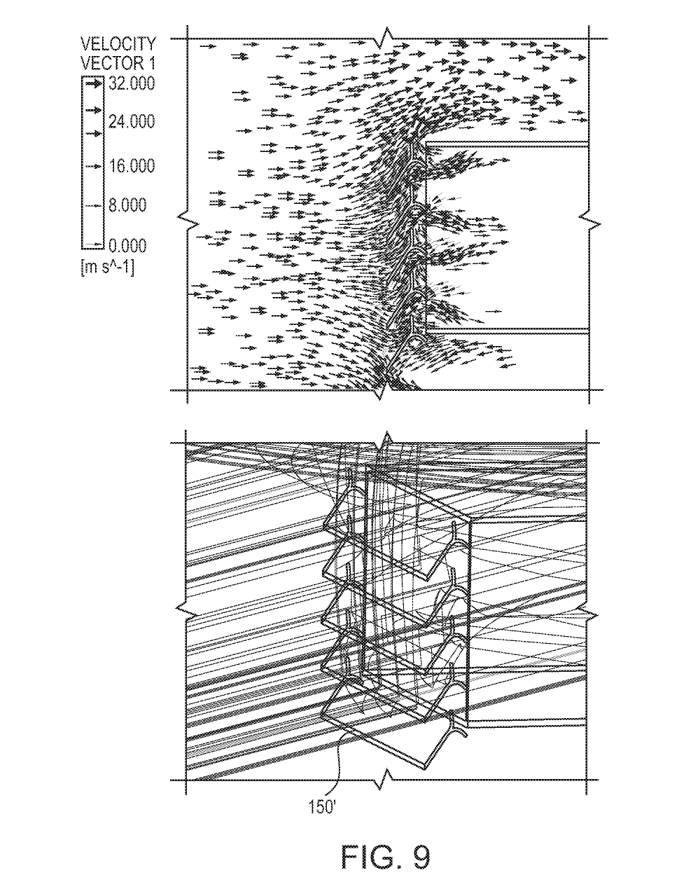

As depicted in FIG. 9, airflow through the grill 112 is directed upwardly via the upstream section 200 of one of the blades 150′ and toward the first part 210 of the downstream section 202 of the one blade 150′. The first part 210 deflects the airflow upwardly toward the downstream section 202 of the blade 150′ located a predetermined distance above the one blade 150′. At least a portion of the airflow flows into the second part 212 and at least another portion of the airflow flows between the blades 150′ and toward the upstream face of the radiator 110. The curvature of the second part 212 turns the debris entrained in the airflow at a high rate creating friction between an interior surface 240 of the second part 212 (FIG. 8) and the debris slowing it down and allowing gravity to pull the debris down and out of the cooling system. The at least partially cleaned portion of the airflow then flows between the blades 150′ and toward the upstream face of the radiator 110. With the configuration of the blades 150′, airflow is directed substantially parallel to the upstream face of the radiator 110 with much less (about 21%) of incident debris entering the radiator 110. Further, the curved profile of the second part 212 of the blade 150′ decreases the pressure drop across the blade 150′ by moving the separation point of the airflow downstream, reducing the area of low pressure behind the blade 150′. It should be appreciated that the second part 212 of the downstream portion 202 of the uppermost blade 150′ directs the airflow over an upper portion of the radiator 110 and the upstream section 200 of the lowermost blade directs the airflow away from the lower portion of the radiator 110. Further, with this design of the blade 150′, the mass flow through the blades 150′ is comparable to the mass flow through the blades 130.

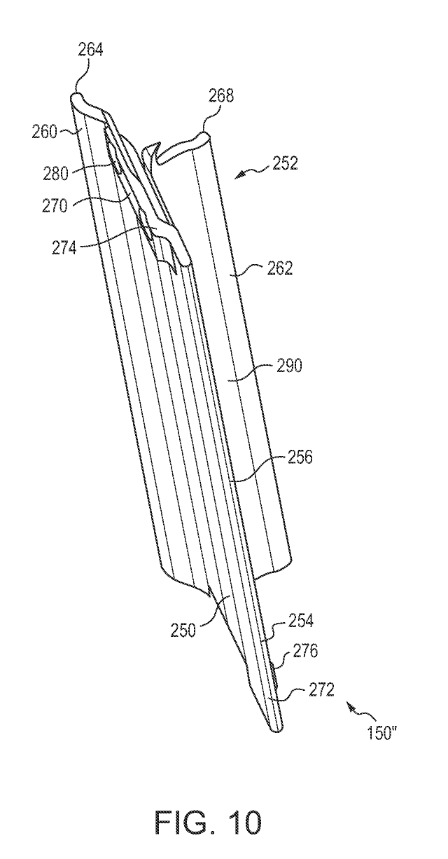

FIG. 10 depicts a blade 150″ according to another aspect of the present disclosure. The blade 150″ includes an upstream section 250 and a downstream section 252. The upstream section 250 has a front end 254 from which the upstream section 250 extends upwardly and rearwardly (toward the radiator) a predetermined distance and a rear end 256 from which the downstream section 252 rearwardly extends. The downstream section 252 includes a first part 260 and a second part 262, each part 260,262 projecting from the rear end 256 of the upstream section 250. The first part 260 extends substantially parallel to an upstream face of the radiator 110 and toward the rear end of the blade 150″ located immediately above the first part 210. The first part 260 is slightly convex in cross-section with an end 264 of the first part 260 being curved away from the upstream section 250 and toward the upstream face of the radiator 110. The second part 262 is slightly concave in cross-section with an end 268 curved upwardly and toward the upstream face of the radiator 110. Similar to the blade 150′ (FIG. 8), the second part 262 together with the upstream section 250 of the blade 150″ have a generally reverse L-shape in cross-section. As indicated previously, the blade 150″ can be a separate add-on component that is releasably secured to a blade of a known grill, such as the blade 130 of the grill 112. To that end, longitudinal end portions 270,272 of the blade 150″, particularly the upstream section 250 of the blade, include mounting sections 274,276 configured to be connected to the blade 130. The mounting sections 274,276 can include mounting apertures (only apertures 280 on mounting section 274 are visible in FIG. 10) sized to receive fasteners, such as screws, which secure the blade 150″ to an outer surface of the blade 130.

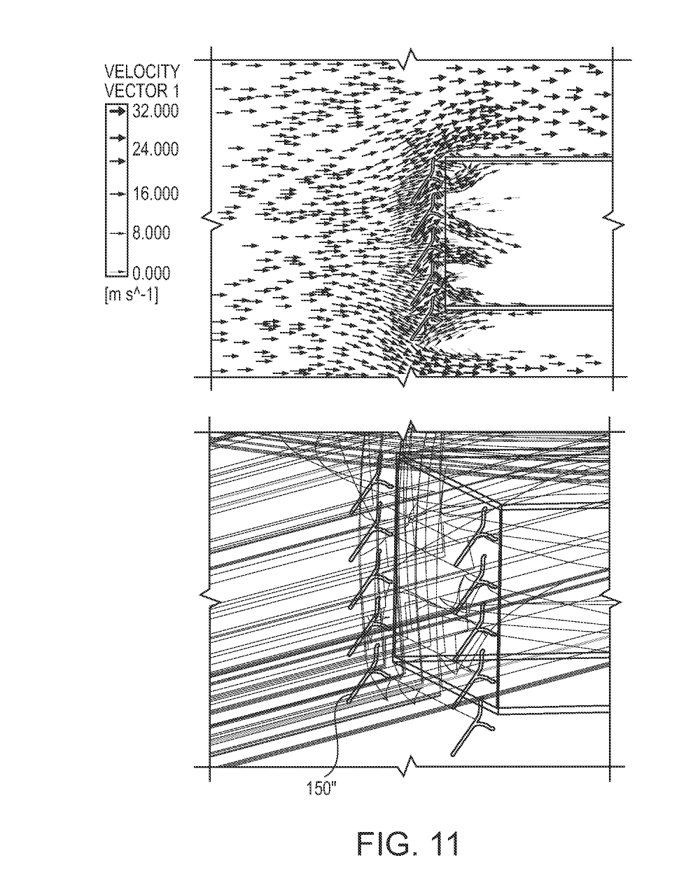

As depicted in FIG. 11, airflow through the grill 112 is directed upwardly via the upstream section 250 of one of the blades 150″ and toward the first part 260 of the downstream section 252 of the one blade 150″. The first part 260 deflects the airflow upwardly toward the downstream section 252 of the blade 150″ located a predetermined distance above the one blade 150″. At least a portion of the airflow flows into the second part 262 and at least another portion of the airflow flows between the blades 150″ and toward the upstream face of the radiator 110. The curvature of the second part 262 turns the debris entrained in the airflow at a high rate creating friction between an interior surface 290 of the second part 262 (FIG. 10) and the debris, slowing it down and allowing gravity to pull the debris down and out of the cooling system 100. The at least partially cleaned portion of the airflow then flows between the blades 150″ and toward the upstream face of the radiator 110. With the configuration of the blades 150″, airflow is directed substantially at about a 20° angle toward the upstream face of the radiator with much less (about 19%) of incident debris entering the radiator 110. The curved profile of the second part 262 of the blade decreases the pressure drop across the blade by moving the separation point of the airflow downstream, reducing the area of low pressure behind the blade. Similar to the design of blade 150′, the second part 262 of the downstream portion 252 of the uppermost blade 150″ directs the airflow over an upper portion of the radiator 110 and the upstream section 250 of the lowermost blade directs the airflow away from the lower portion of the radiator 110. Further, with this design of the blade 150″, the mass flow through the blades 150″ is comparable to the mass flow through the blades 130.

As is evident from the foregoing, all three blades 150,150′,150″ reduce the amount of debris entering the radiator 110, with the blade 150 having no or minimal loss of mass flow compared to the known blade 130. The blades 150′ and 150″ reduce the exposed frontal area of the radiator 110 creating a reduction in flow compared to the blade 150. The blade 150 also displaces the highest reduction in debris without a loss in flow.

The present disclosure further provides a method of separating debris entrained in airflow directed toward a radiator of a vehicle cooling system. The method comprises providing a grill having a plurality of blades upstream of the radiator, each of the blades having an upstream section and a downstream section; curving an end portion of the downstream section of at least one blade downwardly relative to an upstream face of the radiator; directing the debris entrained airflow into the curved end portion of the at least one blade; and imparting a swirl to the airflow entering the curved end portion of the at least one blade to cause debris entrained in the airflow to change direction at a slower rate than the airflow, allowing the debris to be separated from the airflow. The method further comprises creating friction between an inner surface of the curved end portion and the debris to slow movement of the debris entrained in the airflow, decreasing a pressure drop across the at least one blade by moving a separation point of the airflow to the downstream section, which reduces an area of low pressure behind the at least one blade. Additionally, the method comprises curving an end portion of the downstream section of a blade located adjacent to and above the at least one blade downwardly relative to an upstream face of the radiator, and directing the debris entrained airflow into the curved end portion of the adjacent blade via the downstream section of the at least one blade.

It will be appreciated that the various above-disclosed and other features and functions, or alternatives thereof, may be desirably combined into many other different systems or applications. Also, the various presently unforeseen or unanticipated alternatives, modifications, variations or improvements therein may be subsequently made by those skilled in the art which are also intended to be encompassed by the present disclosure and the following claims.

What is claimed is:

1. A grill for a radiator of a vehicle comprising:
a plurality of spaced blades, each blade having an upstream section and a downstream section, wherein a first blade of the plurality of blades includes a first curved portion located on the downstream section of the first blade, and a second blade of the plurality of blades located adjacent to and above the first blade includes a second curved portion located on the downstream section of the second blade, each of the first and second curved portions of the respective first and second blades is configured to impart a swirl to an airflow entering the curved portion which causes debris entrained in the airflow to be separated from the airflow.

2. The radiator grill of claim 1, wherein the downstream section of the first blade is configured to direct the airflow into the second curved portion of the second blade.

3. The radiator grill of claim 1, wherein each of the first and second curved portions of the respective first and second blades projects upwardly from a downstream end of the upstream section, and each of the first and second curved portions has a generally inverted U-shape.

4. The radiator grill of claim 1, wherein the upstream section of each of the respective first and second blades extends upwardly and rearwardly toward an upstream face of a radiator, and the downstream section of each of the respective first and second blades includes a first part projecting in a first direction and a second part projecting in a second direction, each of the first and second curved portions of the respective first and second blades is at least partially defined by the second part.

5. The radiator grill of claim 4, wherein the first part projects upwardly from a downstream end of the upstream section of each of the respective first and second blades and the second part of each of the respective first and second blades is curved downwardly and toward the upstream face of the radiator.

6. The radiator grill of claim 5, wherein the first part of the first blade is substantially aligned with the second part of the second blade to direct airflow into the second curved portion of the second blade.

7. The radiator grill of claim 5, wherein the first part of each of the respective first and second blades has a convex section with an end thereof curved toward the upstream face of the radiator, and the second part of each of the respective first and second blades has a concave section with an end thereof curved toward the upstream face of the radiator.

8. The radiator grill of claim 4, wherein each of the first and second blades is generally a Y-shape.

9. A cooling system for a vehicle comprising:
a radiator;
a grill disposed upstream of the radiator to at least partially cover an upstream face of the radiator, wherein the grill includes a plurality of spaced blades, each blade having an upstream section and a downstream section, and at least one blade of the plurality of blades includes a curved portion located on the downstream section configured to cause debris entrained in an air flow through the grill to change direction at a slower rate than the airflow allowing the debris to be separated from the airflow.

10. The cooling system of claim 9, wherein the curved portion of the at least one blade turns the debris at a high rate creating friction between an inner surface of the curved portion of the at least one blade and debris to slow movement of the debris.

11. The cooling system of claim 10, wherein the curved portion of the at least one blade is configured to decrease a pressure drop across the at least one blade by moving a separation point of the airflow to the downstream section which reduces an area of low pressure behind the at least one blade.

12. The cooling system of claim 11, wherein the upstream section extends upwardly and rearwardly toward the upstream face of the radiator, and the curved portion of the downstream section at least partially defines an air channel shaped to impart a swirl to the airflow entering the channel.

13. The cooling system of claim 12, wherein the downstream section has a generally inverted U-shape.

14. The cooling system of claim 12, wherein the downstream section includes a first part projecting in a first direction and a second part projecting in a second direction, wherein the curved portion is at least partially defined by the second part.

15. The cooling system of claim 14, wherein the first part projects upwardly toward an adjacent blade and the second part is curved downwardly toward the upstream face of the radiator.

16. The cooling system of claim 15, wherein the first part has a convex section with an end thereof curved toward the radiator, and the second part has a concave section with an end thereof curved toward the upstream face of the radiator.

17. A method of separating a debris entrained airflow directed toward a radiator of a vehicle cooling system, comprising:
providing a grill having a plurality of blades upstream of the radiator, each of the blades having an upstream section and a downstream section;
curving an end portion of the downstream section of at least one blade downwardly relative to an upstream face of the radiator;
directing the debris entrained airflow into the curved end portion of the at least one blade; and
imparting a swirl to the airflow entering the curved end portion of the at least one blade to cause debris entrained in the airflow to change direction at a slower rate than the airflow allowing the debris to be separated from the airflow.

18. The method of claim 17, further comprising creating friction between an inner surface of the curved end portion and the debris to slow movement of the debris entrained in the airflow.

19. The method of claim 18, further comprising decreasing a pressure drop across the at least one blade by moving a separation point of the airflow to the downstream section which reduces an area of low pressure behind the at least one blade.

20. The method of claim 17, further comprising curving an end portion of the downstream section of an adjacent blade located above the at least one blade downwardly relative to the upstream face of the radiator, and directing the debris entrained airflow into the curved end portion of the adjacent blade via the downstream section of the at least one blade.
